(19) United States
(12) Patent Application Publication
(10) Pub. No.: US 2025/0354405 A1
(43) Pub. Date: Nov. 20, 2025

(54) COLLAPSIBLE AWNING FRAME

(71) Applicant: David Stanley Steele, Shannon Brook (AU)

(72) Inventor: David Stanley Steele, Shannon Brook (AU)

(21) Appl. No.: 19/207,998

(22) Filed: May 14, 2025

(30) Foreign Application Priority Data
May 15, 2024 (AU) 2024901426

(51) Int. Cl. E04H 15/08

(52) U.S. Cl. CPC E04H 15/08

(57) ABSTRACT

A collapsible awning frame for erecting an awning. The awning frame includes a mounting member adapted to connect to a surface, the mounting member having a first end and a second end. The awning frame also includes a first plurality of nested awning arms pivotably connected to the first end of the mounting member, and a second plurality of nested awning arms pivotably connected to the second end of the mounting member.

### RELATED APPLICATIONS

This application claims priority of Australian Patent Application No. 2024901426, filed May 15, 2024, which is hereby incorporated herein by reference in its entirety.

### TECHNICAL FIELD

The present invention relates generally to vehicle accessories, and more specifically, to a collapsible awning frame and system designed for mounting onto vehicles (including land-based and marine vehicle), trailers, or campers to provide shade and protection from the elements when stationary.

### BACKGROUND

Any references to methods, apparatus or documents of the prior art are not to be taken as constituting any evidence or admission that they formed, or form part of the common general knowledge.

Vehicle awnings have long been utilized to provide shelter and shade during outdoor activities such as camping, picnicking, or tailgating. Traditional awnings, however, often suffer from various drawbacks, including bulkiness, heaviness, difficulty in setup and takedown, and susceptibility to damage from weather conditions.

Existing vehicle awning systems typically includes awnings that are bulky, heavy, and structurally unsound for continuous or mild weather conditions. These traditional awnings often face challenges such as fatigue, bending, blowing upwards, cracking, and difficulty in opening and closing. Additionally, the use of certain materials in prior art awnings can result in rust, corrosion, tearing, and deterioration over time.

Furthermore, traditional awnings may require additional support poles for stability, adding complexity to the setup process. The closing mechanism of prior art awnings may also be cumbersome, with arms stacking onto each other in a bulky manner, potentially leading to rubbing and difficulty in housing properly.

Thus, there exists a need for an improved awning frame and system that addresses the shortcomings of existing awnings and awning systems, providing a lightweight, durable, easy-to-use solution that offers reliable shelter and protection from the elements.

### SUMMARY OF INVENTION

In an aspect, the invention provides a collapsible awning frame for erecting an awning, the awning frame comprising:
a mounting member adapted to connect to a surface, the mounting member having a first end and a second end;
a first plurality of nested awning arms pivotably connected to the first end of the mounting member; and
a second plurality of nested awning arms pivotably connected to the second end of the mounting member.

Preferably, the awning frame is configurable between an extended configuration and a stowed configuration. In the stowed configuration, the first plurality of nested awning arms and the second plurality of nested awning arms are nested within the mounting member. In the extended configuration, the first plurality of nested awning arms and the second plurality of awning arms extend from the mounting member at one or more angles.

Preferably, the surface is an upright or vertical surface, such that the pluralities of arms extend horizontally and outwardly from the mounting member and away from the surface, in use. Preferably, the surface is a portion of a vehicle.

Preferably, the mounting member is adapted to connect to a roof mounting system connected to the vehicle.

Preferably, the mounting member comprises a substantially rectangular plate having two parallel portions extending therefrom. The rectangular plate and two parallel portions together form a C-channel.

Preferably, the mounting member comprises one or more meshed portions.

Preferably, the first plurality of nested awning arms and the second plurality of nested awning arms are adapted to nest within the mounting member.

Preferably, the first plurality of nested awning arms are adapted to pivot about the first end of the mounting member.

Preferably, the first plurality of nested awning arms are adapted to pivot up to 270° relative to the mounting member. More preferably, the first plurality of nested awning arms are adapted to pivot up to 270° relative to the first end of mounting member.

Preferably, the first plurality of nested awning arms are adapted to pivot about a first transverse axis at the first end of the mounting member.

Preferably, the first plurality of nested awning arms are connected at a distal end of the two parallel portions of the mounting member relative to the rectangular plate.

Preferably, the first plurality of nested awning arms comprises two nested awning arms.

Preferably, the first plurality of nested awning arms each include a channel.

Preferably, the channel is orientated toward the mounting member.

Preferably, each arm of the first plurality of nested awning arms comprises one or more meshed portions.

Preferably, the second plurality of nested awning arms are adapted to pivot about the second end of the mounting member.

Preferably, the second plurality of nested awning arms are adapted to pivot up to 270° relative to the mounting member. More preferably, the second plurality of nested awning arms are adapted to pivot up to 270° relative to the second end of the mounting member.

Preferably, the second plurality of nested awning arms are adapted to pivot about a second transverse axis at the second end of the mounting member.

Preferably, the second plurality of nested awning arms are connected at a distal end of the two parallel portions of the mounting member relative to the rectangular plate.

Preferably, the second plurality of nested awning arms comprises up to four nested awning arms.

Preferably, each arm of the second plurality of nested awning arms comprises one or more meshed portions.

Preferably, the first plurality of nested awning arms each include a channel.

Preferably, the channel is orientated away from the mounting member.

In another aspect, the invention provides a method for erecting an awning, the method including:
connecting an awning frame to a surface;
pivoting a first plurality of awning arms connected to a first end of a mounting member of the awning frame out from the mounting member so as to be disposed at one or more angles relative to the mounting member; and
pivoting a second plurality of awning arms connected to a second end of the mounting member of the awning frame out from the mounting member so as to be disposed at one or more angles relative to the mounting member.

In another aspect, the invention provides a collapsible awning frame for erecting an awning, the awning frame comprising:
a mounting member adapted to connect to a surface, the mounting member having a first end and a second end;
at least one awning arm pivotably connected to the first end of the mounting member; and
at least one awning arm pivotably connected to the second end of the mounting member.

In another aspect, the invention provides a collapsible awning frame for erecting an awning, the awning frame comprising:
a mounting member adapted to connect to a surface, the mounting member having a first end and a second end; and
a plurality of nested awning arms pivotably connected to the first end of the mounting member.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of an awning frame in an extended configuration according to an embodiment of the present invention;

FIG. 2 is top view of the awning frame of FIG. 1;

FIG. 3 is a further perspective view of the awning frame of FIG. 1;

FIG. 4 is a perspective view of the awning frame in the stowed configuration;

FIG. 5 is a further perspective view of the awning frame in the stowed configuration;

FIG. 6 is top view of the awning frame in the stowed configuration;

FIG. 7 is a perspective view of an awning frame in an extended configuration according to another embodiment of the present invention; and

FIG. 8 is a perspective view of another awning frame in an extended configuration according to an embodiment of the present invention.

### DETAILED DESCRIPTION OF PREFERRED EMBODIMENTS

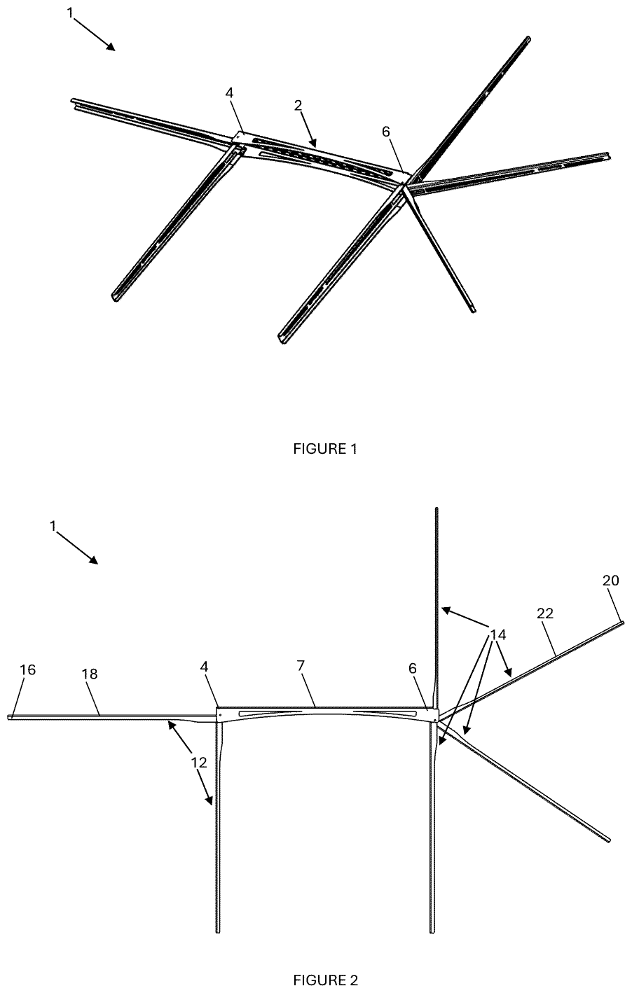

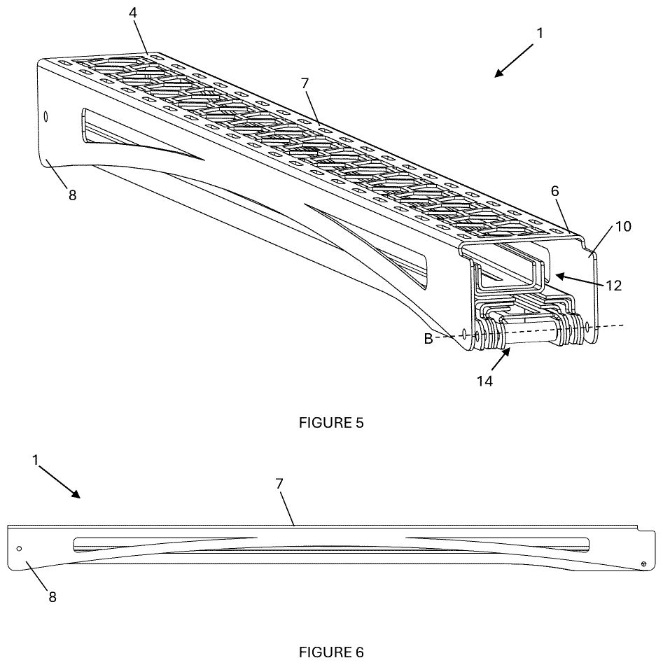

FIGS. 1 to 8 illustrate embodiments of a collapsible awning frame 1 for erecting an awning.

The collapsible awning frame 1 includes a mounting member 2 adapted to connect to a surface (preferably a vertical surface, for example). The surface may be an upright or vertical surface, such that the pluralities of arms extend horizontally and outwardly from the mounting member and away from the surface, in use. The intended use for the awning frame is to be attached to the side of a vehicle (including a land-based vehicle or a marine vehicle), trailer or camper but the awning frame could be used with any surface it can be attached to.

In the illustrations, the mounting member 2 has a first end 4 and a second end 6.

The mounting member also includes a mounting plate 7 in the form of a substantially rectangular plate but the mounting plate 7 may be any shape.

The mounting member 2 includes two parallel portions 8, 10 extending from the mounting plate 7. The two parallel portions 8, 10 may be orthogonal to the mounting plate 7. The mounting plate 7 and two parallel portions 8, 10 together form a C-channel-type member.

In the illustrated embodiment shown in FIGS. 1 to 6, the awning frame 1 also includes a first plurality of nested awning arms 12 pivotably connected to the first end 4 of the mounting member 2, and a second plurality of nested awning arms 14 pivotably connected to the second end 6 of the mounting member 2.

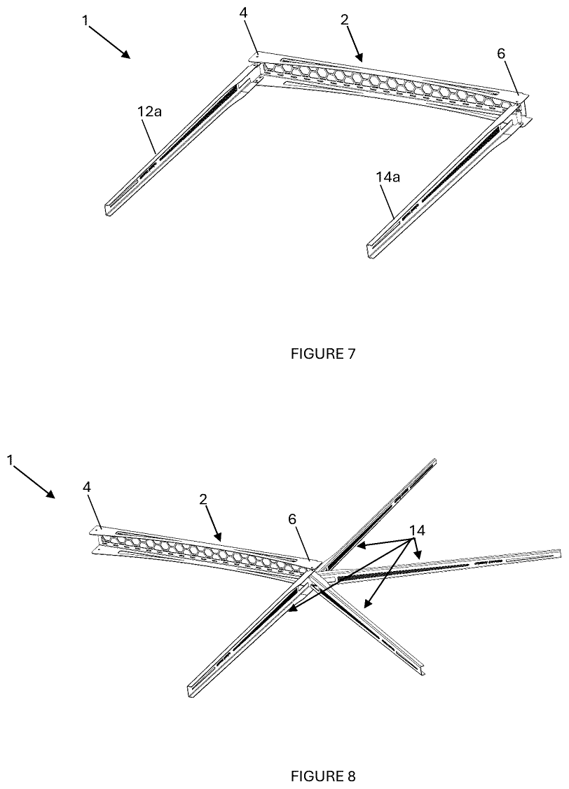

However, in some embodiments, as illustrated in FIG. 7, the awning frame 1 may include a single awning arm 12a pivotably connected to the first end 4 of the mounting member 2, and a single awning arm 14a connected to the second end 6 of the mounting member 2. These awning arms may be configured to pivot up to 270° about the first end 4.

In yet further embodiments illustrated in FIG. 8, the awning frame 1 may include a first plurality of nested awning arms 12 pivotably connected to one end (for example, the second end 6 of the mounting member 2 in the illustration), without a second plurality of nested awning arms at the other end of the mounting member 2. Each awning arm may be configured These awning arms may be configured to pivot up to 270° relative to its respective first end 4 and second end 6 of the mounting member 2.

The first and second pluralities of nested awning arms 12, 14 are adapted to pivot about the respective ends of the mounting member 2.

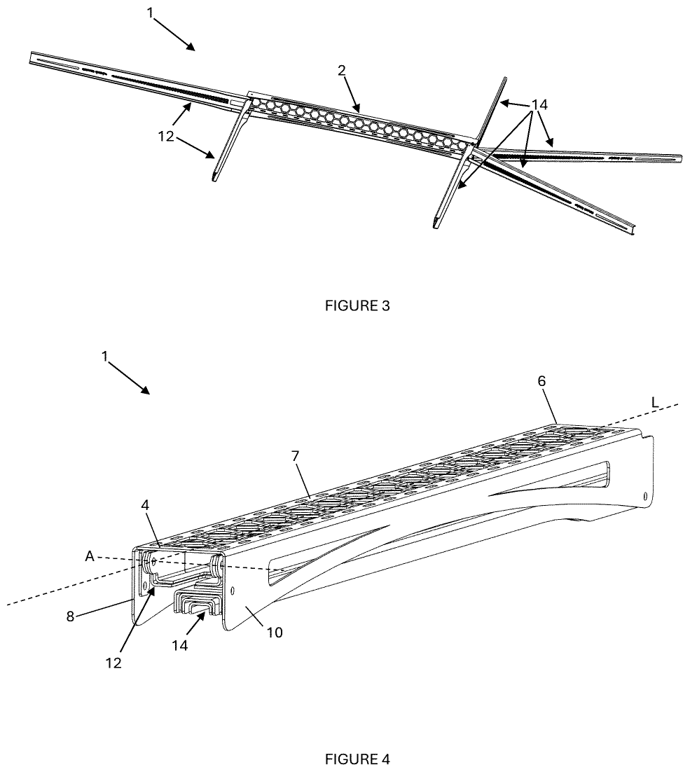

The pivotably connected first and second pluralities of nested awning arms 12, 14 allow the awning frame 1 to be configurable between an extended configuration and a stowed configuration. In the stowed configuration, the first plurality of nested awning arms 12 and the second plurality of nested awning arms 14 are nested within the mounting member 2 (see FIGS. 4 to 6).

Furthermore, in the stowed configuration, a distal end 16 of each arm 18 of the first plurality of nested awning arms 12 relative to the connection to the mounting member 2 is adjacent to the second end 6 of the mounting member 2. As such, each arm 18 of the first plurality of nested awning arms 12 is arranged substantially parallel to the mounting member 2, and in particular the mounting plate 7.

Similarly, a distal end 20 of each arm 22 of the second plurality of nested awning arms 14 relative to the connection to the mounting member 2 is adjacent to the first end 4 of the mounting member 2. As such, each arm 20 of the second plurality of nested awning arms 22 is arranged substantially parallel to the mounting member 2, and in particular the mounting plate 7.

In the extended configuration (see FIGS. 1 to 3), the first plurality of nested awning arms 12 and the second plurality of awning arms 14 extend from the mounting member 2 at one or more angles.

The first plurality of nested awning arms 12 are adapted to pivot about the first end 4 of the mounting member 2.

The first plurality of nested awning arms 12 may be adapted to pivot up to 180° relative to the mounting member 2 and, in particular, to pivot up to 180° relative to the first end 4 of mounting member 2. However, in some embodiments, the first plurality of nested awning arms may be adapted to pivot up to 90° or 270°. The arms may therefore be arranged at various angles. For example, a first arm of the first plurality of nested awning arms 12 may be arranged at 90° relative to the mounting member 2 while a second arm of the first plurality of nested awning arms 12 may be arranged at 180° relative to the mounting member 2.

The pivoting of the first plurality of nested awnings arms 12 may be understood as being about a first transverse axis A at the first end 4 of the mounting member 2. Transverse axis A extends perpendicular to a longitudinal axis L of the mounting member 2. References to angles can be understood as being measured from the 0° stowed position, wherein each arm is nested and parallel within the C-channel (and parallel to a longitudinal axis thereof), through to 180° (and beyond), in which each arm is parallel to the longitudinal axis of the mounting member but oriented on the exterior side of the channel.

The first plurality of nested awning arms 12 may be connected at a distal end of the two parallel portions 8, 10 of the mounting member 2 relative to the mounting plate 7. This assists with allowing the arms to nest effectively.

In the illustrated embodiment, the first plurality of nested awning arms 12 includes two nested awning arms 18 but the number can be varied. In some embodiments, the first plurality of nested awning arms may include two, three, four or five nested awning arms.

The first plurality of nested awning arms 12 each include a channel that may be orientated toward the mounting member 2. The channels may have a substantially C-shaped cross-section. Once again, this may be useful for nesting the arms.

The second plurality of nested awning arms 14 are adapted to pivot about the second end 6 of the mounting member.

The second plurality of nested awning arms 14 may be adapted to pivot up to 270° relative to the mounting member 2 and, in particular, to pivot up to 270° relative to the second end 6 of the mounting member 2. However, in some embodiments, the second plurality of nested awning arms may be adapted to pivot up to 90° or 180°. The arms may therefore be arranged at various angles. For example, a first arm of the second plurality of nested awning arms 14 may be arranged at 90° relative to the mounting member 2, a second arm of the second plurality of nested awning arms 14 may be arranged at 135° relative to the mounting member 2, a third arm of the second plurality of nested awning arms 14 may be arranged at 225° relative to the mounting member 2 and a fourth arm of the second plurality of nested awning arms 14 may be arranged at 270° relative to the mounting member 2. In another example, a first arm of the second plurality of nested awning arms 14 may be arranged at 90° relative to the mounting member 2, a second arm of the second plurality of nested awning arms 14 may be arranged at 180° relative to the mounting member 2, and a third arm of the second plurality of nested awning arms 14 may be arranged at 270° relative to the mounting member 2.

The pivoting of the second plurality of nested awnings arms 14 may be understood as being about a second transverse axis B at the second end of the mounting member. Transverse axis B extends perpendicular to a longitudinal axis L of the mounting member 2. References to angles can be understood as being measured from the 0° stowed position, wherein each arm is nested and parallel within the C-channel (and parallel to a longitudinal axis thereof), through to 180° (and beyond), in which each arm is parallel to the longitudinal axis of the mounting member but oriented on the exterior side of the channel.

The second plurality of nested awning arms 14 may be connected at a proximal end of the two parallel portions 8, 10 of the mounting member 2 relative to the mounting plate 7. This assists with allowing the arms to nest effectively and helps with the nested awning arms at opposite ends of the mounting member to cooperate to nest.

In the illustrated embodiment, the second plurality of nested awning arms 14 includes four nested awning arms 22 but the number can be varied. In some embodiments, the second plurality of nested awning arms may include two, three, four or five nested awning arms.

Similar to the first plurality of nested awning arms 12, the second plurality of nested awning arms 14 each include a channel. However, the second plurality of nested awning arms have channels that may be orientated away (outwardly) from the mounting member. These channels may have a substantially C-shaped cross-section to facilitate the nesting.

The awning frame 1 may include one or more meshed portions. In particular, the mounting member 2, first plurality of nested awning arms 12 and the second plurality of nested awning arms 14 may include one or more meshed portions. The meshed portions have a number of apertures that reduce the amount of material required and reduces the overall weight of the awning frame.

The following is a method for using an awning frame to erect an awning.

The method includes first connecting an awning frame to a surface. Next, the method includes pivoting a first plurality of awning arms connected to a first end of a mounting member of the awning frame out from the mounting member so as to be disposed at one or more angles relative to the mounting member.

In a third step, the method includes pivoting a second plurality of awning arms connected to a second end of the mounting member of the awning frame out from the mounting member so as to be disposed at one or more angles relative to the mounting member.

In use, the awning is designed to mount to the side roof of vehicle, trailer or camper via a bracket or similar. Fabric or a cover material can be added to the awning frame to provide a widespread shaded canvas awning that unfolds and spreads around the exterior of the vehicle, trailer or camper. This provides shade from the sun, elements and rain when outdoors when stationary and not in use.

An advantage of embodiments of the awning frame is that it can be opened (extended), set up and closed (stowed) quickly and easily. Once opened, the awning is to be fastened down using straps to hold the arms in place and avoid folding when in use. The arms work on a two-pivot bearing system to ensure seamless manoeuvring. When in use there is no need to position in place with poles as the level of strength in the arms is strong enough to withstand without support.

Embodiments of the invention provide a structurally engineered, user friendly, aesthetically pleasing and seamless operating experience. The invention eliminates or reduces weld points to avoid cracking, fatigue and wear and tear.

Using C channel arms that are CNC cut/folded and partially meshed also reduces overall weight.

The invention provides a nesting system of arms to ensure each arm perfectly sleeves back into place every single time. This provides less stress on the pivots as they house together avoiding movement when vehicle/trailer/camper is in use.

In the stowed configuration, the invention is also compact and unobtrusive.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A collapsible awning frame for erecting an awning, the awning frame comprising:
a mounting member adapted to connect to a surface, the mounting member having a first end and a second end;
a first plurality of nested awning arms pivotably connected to the first end of the mounting member; and
a second plurality of nested awning arms pivotably connected to the second end of the mounting member.

2. The collapsible awning frame according to claim 1, wherein the awning frame is configurable between an extended configuration and a stowed configuration.

3. The collapsible awning frame according to claim 2, wherein in the stowed configuration, the first plurality of nested awning arms and the second plurality of nested awning arms are nested within the mounting member.

4. The collapsible awning frame according to claim 3, wherein in the extended configuration, the first plurality of nested awning arms and the second plurality of awning arms extend from the mounting member at one or more angles.

5. The collapsible awning frame according to claim 1, wherein the surface is an upright or vertical surface, such that the pluralities of arms extend horizontally and outwardly from the mounting member and away from the surface, in use.

6. The collapsible awning frame according to claim 1, wherein the surface is a portion of a vehicle and the mounting member is adapted to connect to a roof mounting system connected to the vehicle.

7. The collapsible awning frame according to claim 1, wherein the mounting member comprises a substantially rectangular plate having two parallel portions extending therefrom, and the rectangular plate and two parallel portions together form a C-channel.

8. The collapsible awning frame according to claim 1, wherein the first plurality of nested awning arms and the second plurality of nested awning arms are adapted to nest within the mounting member.

9. The collapsible awning frame according to claim 1, wherein the first plurality of nested awning arms are adapted to pivot about the first end of the mounting member.

10. The collapsible awning frame according to claim 9, wherein the first plurality of nested awning arms are adapted to pivot up to 180° relative to the first end of mounting member.

11. The collapsible awning frame according to claim 10, wherein the first plurality of nested awning arms are adapted to pivot about a first transverse axis at the first end of the mounting member.

12. The collapsible awning frame according to claim 7, wherein the first plurality of nested awning arms are connected at a distal end of the two parallel portions of the mounting member relative to the rectangular plate.

13. The collapsible awning frame according to claim 1, wherein the first plurality of nested awning arms comprises two nested awning arms.

14. The collapsible awning frame according to claim 1, wherein the first plurality of nested awning arms each include a channel, wherein the channel is orientated toward the mounting member.

15. The collapsible awning frame according to claim 1, wherein the second plurality of nested awning arms are adapted to pivot about the second end of the mounting member.

16. The collapsible awning frame according to claim 15, wherein the second plurality of nested awning arms are adapted to pivot up to 270° relative to the second end of the mounting member.

17. The collapsible awning frame according to claim 16, wherein the second plurality of nested awning arms are adapted to pivot about a second transverse axis at the second end of the mounting member.

18. The collapsible awning frame according to claim 12, wherein the second plurality of nested awning arms are connected at a distal end of the two parallel portions of the mounting member relative to the rectangular plate.

19. The collapsible awning frame according to claim 1, wherein the second plurality of nested awning arms comprises up to four nested awning arms.

20. A method for erecting an awning, the method including:
connecting an awning frame to a surface;
pivoting a first plurality of awning arms connected to a first end of a mounting member of the awning frame out from the mounting member so as to be disposed at one or more angles relative to the mounting member; and
pivoting a second plurality of awning arms connected to a second end of the mounting member of the awning frame out from the mounting member so as to be disposed at one or more angles relative to the mounting member.
